(19) United States
(12) Patent Application Publication
(10) Pub. No.: US 2023/0299378 A1
(43) Pub. Date: Sep. 21, 2023

(54) BATTERY PACK STRUCTURE

(71) Applicants: HYUNDAI MOTOR COMPANY, Seoul (KR); KIA CORPORATION, Seoul (KR)

(72) Inventors: Sang Ha Lee, Suwon-si (KR); Ki Jung Kim, Yongin-si (KR); Hye Rim Oh, Hwaseong-si (KR); Jee Jung Kim, Yongin-si (KR); Min Woo Kim, Gyeongsan-si (KR); Dong Hyun Moon, Gyeongsan-si (KR); Min Sung Kim, Gyeongsan-si (KR); Ji Woong Kang, Gyeongsan-si (KR); Young Wan Kim, Gyeongsan-si (KR)

(73) Assignees: HYUNDAI MOTOR COMPANY, Seoul (KR); KIA CORPORATION, Seoul (KR)

(21) Appl. No.: 18/090,034

(22) Filed: Dec. 28, 2022

(30) Foreign Application Priority Data
Mar. 16, 2022 (KR) 10-2022-0032456

(51) Int. Cl. H01M 10/637; H01M 50/213; H01M 10/615; H01M 10/6571; H01M 10/625

(52) U.S. Cl. CPC H01M 10/637; H01M 50/213; H01M 10/615; H01M 10/6571; H01M 10/625; H01M 2220/20

(57) ABSTRACT

A battery pack structure includes: a battery cell unit which is provided with a plurality of battery cells and configured to transmit power to a vehicle, a temperature sensor unit which measures a temperature of the battery cell unit, a heating unit which is installed apart in the battery cell unit and configured to transmit heat to the battery cell unit, and a control unit which is connected to the temperature sensor unit and the heating unit, and receives a temperature signal from the temperature sensor unit to control operations of the heating unit.

### CROSS-REFERENCE TO RELATED APPLICATION

This application claims under 35 U.S.C. § 119(a) the benefit of priority to Korean Patent Application No. 10-2022-0032456 filed on Mar. 16, 2022 in the Korean Intellectual Property Office, the entire contents of which are incorporated herein by reference.

### TECHNICAL FIELD

The present disclosure relates to a battery pack structure, and specifically, to a battery pack structure having a heating plate formed to enclose a battery cell unit and a heating unit configured to enclose the heating plate, thereby improving uniformity of a temperature increase rate and a temperature of the battery cell unit.

### BACKGROUND

With rapid increase in interest in the environment, interest in electric vehicles using a motor based on batteries instead of existing vehicles using an internal combustion engine is increased abruptly. One of the most important elements of such an electric vehicle is a battery.

In the past, lead storage batteries were used as vehicle electrical batteries. However, in use as a power source of the vehicle, lead storage batteries are low in terms of an amount of electricity which can be stored in comparison with a weight and a volume thereof, i.e., electrical charge capacity. For this reason, lithium series batteries capable of providing a greater charge capacity compared to weight thereof are mainly used as batteries for such an electric vehicle.

A battery is a device that is basically designed to be able to interchange chemical energy with electrical energy. Use of a secondary battery in which charging and discharging can occur simultaneously has become common in a range of devices.

However, a chemical reaction occurring inside the battery is influenced by ambient environmental conditions, as in the case of general chemical reactions, and particularly, is greatly influenced by a temperature. For instance, self-safety is lowered by an abnormal reaction, the battery itself may be damaged in a zone of a high temperature at which self-damage can occur, and a fire, or the like, may occur in a vehicle to which the battery is applied.

In contrast, the battery cannot provide efficient power supply in a low-temperature cold weather environment in which the chemical reaction is reduced, so that travel of the vehicle itself can become difficult. It may be difficult for the lithium ion battery pack used in most electric vehicles to provide sufficient power to a vehicle because performance thereof may be reduced at a low temperature in winter, in regions in which four seasons are distinct, such as in Korea. Such a battery may be lowered in charge efficiency, not charged to an expected capacity, and increased in terms of charging time. For instance, at a temperature of about −6° C., complete charging is not performed due to an increase of resistance during charging of the battery. Due to a phenomenon in which output is reduced, only output performance lower than 50% is exerted. When the battery is continuously used at low temperature, a lifespan thereof is reduced, and a changing time may be faster. Thus, there may occur a problem in which maintenance expenses of the battery are increased.

In the past, in order to prevent performance of a battery from being lowered by such a seasonal reduction in temperature, a temperature of the battery inside the electric vehicle or an ambient temperature around a location in which the battery was disposed was measured. When the temperature was lower than a fixed level, a heater installed around the battery was operated, and reduction in performance of the battery was prevented. These techniques have been introduced.

Such a heater mainly makes use of a heating method based on convection, in that good use of air is made by applying a heat generating element to a fan in a large battery or an indirect heating method of heating a coolant. In contrast, in the case of a small battery pack, a method of mounting a heat generating element on a case of the battery pack to increase an internal temperature of the battery pack, or a method of directly attaching heat generating elements to surfaces of battery cells or electrode elements and performing heating is used.

In the aspect of the heating rate and uniformity among the heating performances of the battery, the method of applying the heat generating element to a fan or a coolant and indirectly heating the battery cells is the best. However, because the fan, a coolant pump, and the like, should be installed, an increase in weight or mass production cost is problematic, and thus, this method is mainly applied to large batteries.

In small batteries, a method of directly mounting the heat generating element on the battery cells or a method of attaching the heat generating element to the case has been used. In the case of directly mounting the heat generating element on the battery cells, a heating rate is fast, a large temperature difference occurs between the cells. When the batteries are exposed to vibrations etc. for an extended period of time, there may occur a problem with durability, such as destruction of the adhesion between the battery cell and the heat generating element.

When only the heat generating element is mounted on the case, only a temperature of air surrounding the heat generating element increases locally, and a rate of increase of the battery cell temperature is slow, so that a temperature deviation between the battery cells may be a significant problem.

The above information disclosed in this Background section is only for enhancement of understanding of the background of the disclosure and accordingly it may include information that does not form prior art that is already known in this country to a person of ordinary skill in the art.

### SUMMARY OF THE DISCLOSURE

The present disclosure has been made in effort to solve the above problem, and an object of the present disclosure is to provide a battery pack structure in which an increase rate and uniformity of a temperature of battery cells by providing a heating plate formed to enclose a battery cell unit, and a heating unit configured to enclose the heating plate.

Further, another object of the present disclosure is to provide a battery pack structure that controls whether or not a heating unit is operated through a control unit, so that aging or a fire resulting from precipitation of lithium of battery cells can be prevented.

An object of the present disclosure is not limited to the above-mentioned objects, and other objects of the present disclosure not mentioned will be clearly understood by those skilled in the art to which the present disclosure pertains from the following description. Further, the objects of the present disclosure can be realized by means given to the Claims and combinations thereof.

A battery pack structure for achieving the objects of the present disclosure includes configurations as follows.

According to an embodiment of the present disclosure, provided is a battery pack structure configured to include: a battery cell unit provided with a plurality of battery cells and configured to transmit power to a vehicle; a temperature sensor unit configured to measure a temperature of the battery cell unit; a heating unit installed apart in the battery cell unit and configured to transmit heat to the battery cell unit; and a control unit connected to the temperature sensor unit and the heating unit, and configured to receive a temperature signal from the temperature sensor unit to control operations of the heating unit.

In addition, the heating unit may be configured to include: a heating plate configured to enclose the battery cell unit; and a heat generating member configured to generate heat electrically.

Further, the heat generating member may be disposed outside the heating plate.

Further, the heat generating member may be configured integrally with the heating plate.

Further, the battery pack structure may further include a guide section configured to enclose the battery cell unit, and includes a guide groove into which opposite sides of the heating plate are configured to be inserted.

Further, the battery cell unit and the heating plate may be configured to be separated by 7 mm or less.

Further, the heat generating member may be formed of one selected from the group consisting of a thermal wire, a silver nanowire, and a positive temperature coefficient (PTC) material.

Also, the heating plate may be formed of a metal material.

Further, the control unit may control operations of the heating unit when the temperature sensor unit detects a temperature which is lower than a first critical temperature in a state in which the heating unit is not operated.

Further, the control unit may control operations of the heating unit to be stopped when the temperature sensor unit detects a temperature corresponding to a second critical temperature in a state in which the heating unit is operated.

Further, the heating plate may be configured to enclose at least three surfaces of the battery cell unit.

Further, the battery pack structure may further include an electrode plate guide located between the battery cells.

In addition, the control unit may control operations of the heating unit to be stopped when a preset time has elapsed after the heating unit is operated.

Through the above configuration, the battery pack structure according to the present disclosure provides the following effects.

A heating plate is formed to enclose a battery cell unit and a heating unit is formed to enclose the heating plate, so that a temperature increase rate of the battery cell unit is increased, and the battery cell unit is heated at a uniform temperature.

Further, whether or not a heating unit is operated is controlled through a control unit, so that aging or a fire resulting from precipitation of lithium of battery cells is prevented, and thereby, a reduction in quality of the battery pack can be reduced.

The effects of the present disclosure are not limited to the above-mentioned effects, and other effects of the present disclosure not mentioned herein will be clearly understood by those skilled in the art to which the present disclosure pertains from the following description.

It is understood that the terms “vehicle,” “automobile” or other similar terms, as used herein, are inclusive of motor vehicles in general such as passenger vehicles including sports utility vehicles (SUV), buses, trucks, various commercial vehicles, watercrafts, including a variety of boats and ships, aircraft, and the like, and includes hybrid vehicles, electric vehicles, plug-in hybrid electric vehicles, hydrogen-powered vehicles and other alternative fuel vehicles (e.g., vehicles powered by fuels derived from resources other than petroleum). As referred to herein, a hybrid vehicle is a vehicle that has two or more sources of power, for example both gasoline-powered and electric-powered vehicles.

The above and other features of the disclosure are discussed hereinafter.

### BRIEF DESCRIPTION OF THE DRAWINGS

The above and other features of the present disclosure will now be described in detail with reference to certain exemplary examples thereof illustrated in the accompanying drawings which are given herein below by way of illustration only, and thus are not limitative of the present disclosure, and wherein:

FIG. 1 is a perspective view of a battery pack structure as an embodiment of the present disclosure;

FIG. 2 is a schematic view of the battery pack structure as an embodiment of the present disclosure;

FIG. 3 illustrates a separation distance between a battery cell unit and a heating plate of the battery pack structure as an embodiment of the present disclosure;

FIG. 4 is a graph indicating heating performance depending on the separation distance between the battery cell unit and the heating plate according to an embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in section by the particular intended application and use environment.

In the figures, reference numbers refer to the same or equivalent sections of the present disclosure throughout the several figures of the drawing.

### DETAILED DESCRIPTION

Specific structural or functional descriptions presented in the embodiments of the present disclosure are only exemplified for the purpose of describing the embodiments according to the concept of the present disclosure, and the embodiments according to the concept of the present disclosure may be carried out in various forms.

In addition, throughout this specification, when a portion “includes” a certain component, it means that other components may further be included, other than excluding other components, unless specially stated otherwise.

In addition, in this specification, directions such as “forward,” “rearward,” “upward,” and “downward” are based on a vehicle unless otherwise specified. In addition, in this specification, a “longitudinal direction” means a direction extending in a front-rear direction of a vehicle, a “vertical direction” means a direction extending in an up-down direction of a vehicle, and a “lateral direction” means a direction extending in a left-right direction of a vehicle.

In addition, in this specification, the classification of the names of the components into “first,” “second,” etc. is only to distinguish components having the same name, and does not limit the functions or orders of the components.

Hereinafter, embodiments of the present disclosure will be described with reference to the accompanying drawings. Matters expressed in the accompanying drawings may be different from the forms actually implemented as the schematic drawings for easy explanation of the embodiments of the present disclosure.

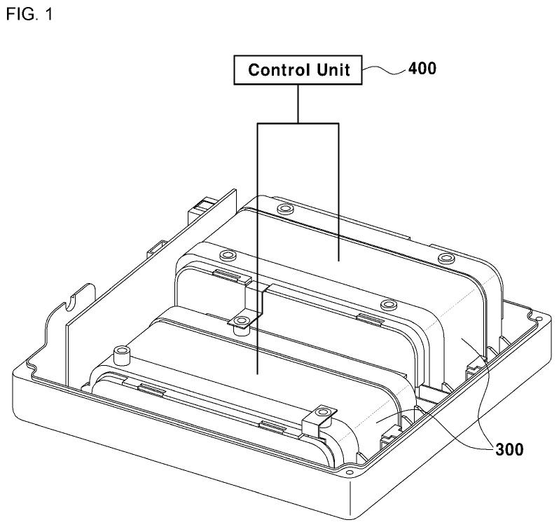

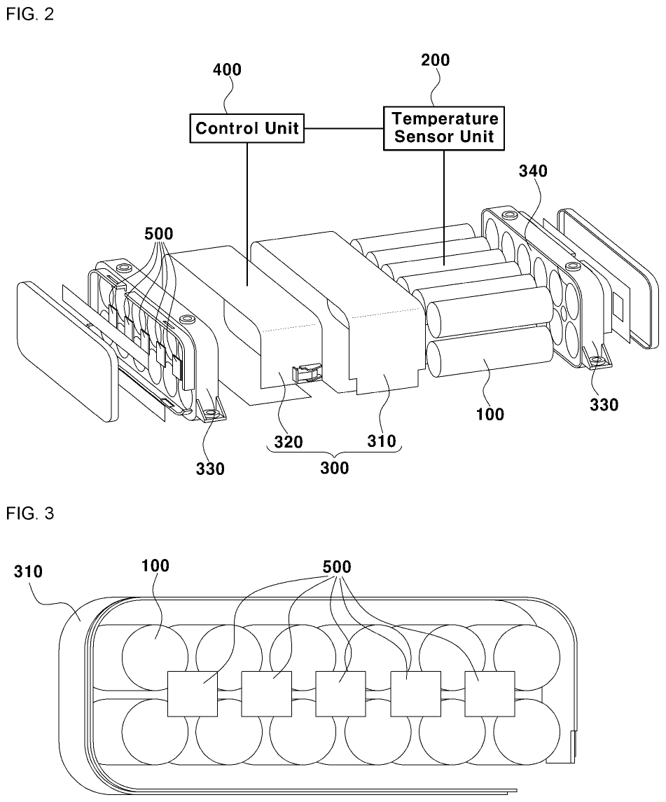

FIG. 1 is a perspective view of a battery pack structure as an embodiment of the present disclosure, and FIG. 2 is a schematic diagram of the battery pack structure as an embodiment of the present disclosure.

Referring to FIGS. 1 and 2, a battery pack structure as an embodiment of the present disclosure may be configured to include a battery cell unit 100, a temperature sensor unit 200, a heating unit 300, a heat generating member 320, and a control unit 400.

The battery cell unit 100 may be configured to transmit power to the vehicle by coupling of a plurality of battery cells. The battery cell unit 100 may consist of a plurality of battery cells. The battery cell unit 100 may be configured to be connected to a load, to supply and discharge power to the load, or may be connected to a charging source, and be supplied and charged with power from the charging source. The load connected to the battery cell unit 100 may be any one or more of components used to drive the electric vehicle. As an embodiment, the load may be a motor.

The battery cell unit 100 may be formed of a lithium battery as an embodiment. The battery cell unit 100 is provided with a cell cover, and may be configured as a single battery pack. More preferably, as illustrated in FIG. 2, the battery cell unit 100 is provided with an upper cell cover and a lower cell cover, and may be configured as a single battery pack.

Electrode plate guides 500 are disposed between the plurality of battery cells, and are configured to guide alignment of the battery cells, such that fastening between the electrode plates and the battery cells is facilitated. The electrode plate guides 500 function to prevent movement of the battery cells and guide the battery cells to be aligned in preset positions when fastening of the electrodes and the battery cells is being undertaken. More preferably, the electrode plate guides are configured integrally with the guide sections 330, and can be fastened to the battery cell unit 100.

The temperature sensor unit 200 can be configured to measure a temperature of the battery cell unit 100. To be more specific, the temperature sensor unit 200 is installed adjacent to the battery cell unit 100, and can be configured to measure the temperature of the battery cell unit 100. The temperature sensor unit 200 may include at least one or more temperature sensors. More preferably, to allow the temperature sensor unit 200 to prevent failures or malfunctions of the temperature sensors included in the temperature sensor unit 200, at least two or more temperature sensors may be installed around the battery cell unit 100. The temperature sensor unit 200 may be configured to measure a temperature of the battery cell unit 100 in the installed position, or ambient temperature of the battery cell unit 100.

Information regarding the temperature of the battery cell unit 100 or information regarding the ambient temperature of the battery cell unit 100 may be transferred to the control unit 400 (to be described below). The temperature sensor unit 200 is connected to the control unit 400 in a wired or wireless manner, and may be configured to transfer the temperature information measured by the battery cell unit 100 to the control unit 400. The temperature sensor unit 200 may include a preset communications module configured to transfer temperature information.

The heating unit 300 can be installed to be separated from the battery cell unit 100. More preferably, the heating unit 300 is formed in a plate shape, and may be configured to enclose the battery cell unit 100 so as to transmit heat generated electrically.

The heating unit 300 can be configured to include a heating plate 310 configured to have enclose the battery cell unit 100 at a fixed width, and a heat generating member 320 that generates heat. The heat generating member 320 may be disposed outside the heating plate 310. Alternatively, the heat generating member 320 may be configured integrally with the heating plate 310.

More preferably, as an embodiment of the present disclosure, the heat generating member 320 may be configured integrally with the heating plate 310 through a characteristic of a construction method such as insert injection. Alternatively, the heat generating member 320 and the heating plate 310 may be configured by bonding after being manufactured as separate structures.

The heating plate 310 may be formed of a metal material. As an embodiment, the heating plate 310 may be formed of an aluminum material having excellent thermal conductivity. The heating plate 310 may be formed of a metal material so as to efficiently conduct heat transfer to the battery cell unit 100.

The heat generating member 320 is bonded to enclose the heating plate 310, and may be configured to generate heat electrically. When a temperature of the battery cell unit 100 is lower than a preset temperature, the heat generating member 320 may be configured to increase an internal temperature of the battery cell unit 100 through electrical heat generation.

The heat generating member 320 may be bonded to an outer surface of the heating plate 310 so as to enclose the heating plate 310. As an embodiment, the heat generating member 320 may have a plate shape configured to enclose the outer surface of the heating plate 310. The heat generated by the heat generating member 320 is conducted to the heating plate 310, and the heating plate 310 may be configured to transfer the heat generated by the heat generating member 320 to the battery cell unit 100 through convection.

The heat generating member 320 may be one selected from the group consisting of a heating wire, a silver nanowire, and a positive temperature coefficient (PTC) heater. As an embodiment, the heat generating member 320 may be the PTC heater. The PTC heater is an electrical heat generating element using a PTC thermistor, and is a heater in which, when heat is generated by electricity, a self-resistance value increases, and in which a current is restricted to generate heat at a nearly constant temperature, despite a change in temperature of ambient air or a change in a power supply voltage.

Further, the battery pack structure includes guide sections 330 located on at least one side of the heating plate 310 and configured to enclose the battery cell unit 100. Each of the guide sections 330 is configured to correspond to the heating plate 310 enclosing the battery cell unit 100, and including guide grooves 340 into and to which at least a part of opposite side ends of the heating plate 310 is inserted and fixed. Thus, the present disclosure including the guide sections 330 can be configured to prevent the heating plate 310 from being separated from the battery cell unit 100.

In an embodiment of the present disclosure, the guide sections 330 are located on opposite sides of the battery cell unit 100, and are configured to enclose four planes of the battery cell unit 100. Parts of opposite ends of the heating plate 310 facing the guide sections 330 are inserted into grooves located in the guide sections 330, and can be fixed to the grooves.

The control unit 400 may be configured to be connected to the temperature sensor unit 200 and the heat generating member 320. According to an exemplary embodiment of the present disclosure, the control unit 400 may include a processor (e.g., computer, microprocessor, CPU, ASIC, circuitry, logic circuits, etc.) and an associated non-transitory memory storing software instructions which, when executed by the processor, provides the functionalities described hereinafter. Herein, the memory and the processor may be implemented as separate semiconductor circuits. Alternatively, the memory and the processor may be implemented as a single integrated semiconductor circuit. The processor may embody one or more processor(s).

The control unit 400 may be configured to receive a temperature signal from the temperature sensor unit 200, and to control an operation of the heat generating member 320. More preferably, the control unit 400 may be configured to operate the heat generating member 320 when the temperature of the battery cell unit 100 is equal to or lower than a preset temperature.

To be more specific, the control unit 400 can control the heat generating member 320 to be operated when a temperature lower than a first critical temperature is detected by the temperature sensor unit 200 in a state in which the heat generating member 320 is not operated. In contrast, the control unit 400 can control the heat generating member 320 to stop operations when a second critical temperature is detected by the temperature sensor unit 200 in a state in which the heat generating member 320 is operated.

As information about the temperature of the battery cell unit 100 which is measured by the temperature sensor unit 200, as an embodiment, the temperature lower than the first critical temperature may refer to a case of less than 0° C. As information about the temperature of the battery cell unit 100 which is measured by the temperature sensor unit 200, as an embodiment, a second critical temperature may refer to a case in which a temperature is maintained for a preset time within a range of 0° C. to 25° C.

The control unit 400 can control the heating unit 300 such that the heating unit 300 is operated when the temperature lower than the first critical temperature is measured from the temperature sensor unit 200 in a state in which the heating unit 300 is not operated. The control unit 400 can be configured to operate the heating unit 300 to raise the temperature of the battery cell unit 100 when the temperature lower than the first critical temperature is measured from the temperature sensor unit 200.

When the vehicle is started or receives a charging signal, the control unit 400 can be configured to check the temperature of the battery cell unit 100. After the control unit 400 checks the temperature of the battery cell unit 100, when the temperature lower than the first critical temperature is not measured from the temperature sensor unit 200, the battery cell unit 100 can be controlled to be charged.

When the second critical temperature is detected by the temperature sensor unit 200 in a state in which the heating unit 300 is operated, the control unit 400 can control the heating unit 300 to stop the operation of the heating unit 300. More specifically, when the second critical temperature is detected by the temperature sensor unit 200, the control unit 400 stops the operation of the heating unit 300, and can perform control such that the battery cell unit 100 is charged.

When a preset time has elapsed after the heating unit 300 is operated, the control unit 400 can control the heating unit 300 to stop the operation of the heating unit 300. The preset time may refer to a minimum time for which the temperature of the battery cell unit 100 is maintained within a range of 0° C. to 25° C. In other words, when a preset time has elapsed after the heating unit 300 is operated, the control unit 400 determines that the battery cell unit 100 is sufficiently heated, and can control the heating unit 300 to stop the operation of the heating unit 300.

As an embodiment, the control unit 400 may be a battery management system (BMS). A reference temperature of the first critical temperature and a temperature range and time of the second critical temperature may be changed according to setting of a user, an environment, design details of the battery, or as needed. More specifically, a switch may be installed between the heat generating member 320 and the battery cell unit 100 that are electrically connected to each other, and the control unit 400 controls ON/OFF switching of the switch, and thus can control whether or not to generate heat with the heat generating member 320.

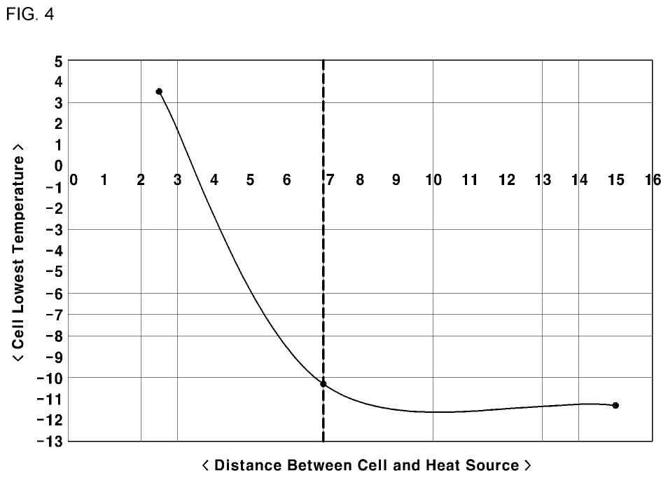

FIG. 3 illustrates a separation distance between the battery cell unit 100 and the heating plate 310 of the battery pack structure as an embodiment of the present disclosure, and FIG. 4 is a graph indicating heating performance depending on the separation distance between the battery cell unit 100 and the heating plate 310 according to an embodiment of the present disclosure.

Referring to FIGS. 3 and 4, the heating plate 310 can be configured to enclose at least three sides of the battery cell unit 100. More preferably, the battery cell unit 100 and the heating plate 310 may be configured to be separated by 7 mm or less. That is, when the heating plate 310 comes into contact with the battery cell unit 100, there may be a problem in that a short phenomenon can occur. Thus, in an embodiment of the present disclosure, the heating plate 310 may be located apart to have a preset interval from the battery cell unit 100.

The heating plate 310 can be configured to enclose at least three sides of the battery cell unit 100. More specifically, the heating plate 310 is separated from at least three sides of the battery cell unit 100 by 7 mm or less, and can be configured to enclose the battery cell unit 100. Heat generated by the heat generating member 320 is conducted to the heating plate 310, and the heating plate 310 is configured to enclose the battery cell unit 100, so that the battery cell unit 100 can be configured to be heated uniformly.

When the separation distance between the heating plate 310 and the battery cell unit 100 is less than 1 mm, mechanical stability is reduced, and heat generating performance of the heat generating member 320 may be lowered. When the separation distance between the heating plate 310 and the battery cell unit 100 exceeds 7 mm, there is a problem that the temperature rising rate of the battery cell unit 100 is reduced. Therefore, in the battery pack structure according to an embodiment of the present disclosure, the separation distance between the heating plate 310 and the battery cell unit 100 can be configured to be maintained from 1 mm to 7 mm.

Under the control of the control unit 400, the heat generating member 320 increases the temperature of the battery cell unit 100, and can prevent a performance drop of the battery cell unit 100 caused by a temperature drop. When power is supplied to the heat generating member 320 and the heat generating member 320 generates heat, the heat is conducted to the heating plate 310, and can be transmitted to the battery cell unit 100 through the heating plate 310 in a convection type. Thereby, it is possible to prevent a durability drop caused by vibrations, etc. generated when the heat generating member 320 is directly fastened to the battery cell unit 100.

As illustrated in FIG. 4, it can be determined that, as the separation distance between the heating plate 310 and the battery cell unit 100 is reduced, a lowest temperature of the battery cell unit 100 is high. When the separation distance between the heating plate 310 and the battery cell unit 100 exceeds 7 mm, a temperature reduction width of the battery cell unit 100 is reduced. This is a result of convention being activated in the separation space between the heating plate 310 and the battery cell unit 100.

To sum up, the present disclosure provides the battery pack structure that includes the heating plate 310 formed to enclose the battery cell unit 100 and the heat generating member 320 configured to enclose the heating plate 310, so that an increase rate and uniformity of a temperature of the battery cells are improved, and controls operation or nonoperation of the heating unit 300 through the control unit 400 to be able to prevent aging and a fire resulting from lithium precipitation from the battery cells.

The above detailed description is provided to illustrate the present disclosure. Additionally, the forgoing contents show and describe the preferred embodiments of the present disclosure, but the present disclosure is capable of use in various other combinations, modifications, and environments, and is capable of changes or modifications within the scope of the inventive concept as expressed herein, commensurate with the above teachings and/or the skill or knowledge of the relevant art. The embodiments described hereinabove are further intended to explain best modes known of practicing the disclosure and to enable others skilled in the art to utilize the disclosure in such, or other, embodiments and with the various modifications required by the particular applications or uses of the disclosure. Accordingly, the description is not intended to limit the disclosure to the form disclosed herein. Also, it is intended that the appended claims be construed to include alternative embodiments

What is claimed is:

1. A battery pack structure comprising:
a battery cell unit provided with a plurality of battery cells and configured to transmit power to a vehicle;
a temperature sensor unit configured to measure a temperature of the battery cell unit;
a heating unit installed apart in the battery cell unit and configured to transmit heat to the battery cell unit; and
a control unit connected to the temperature sensor unit and the heating unit, and configured to receive a temperature signal from the temperature sensor unit to control operations of the heating unit.

2. The battery pack structure of claim 1, wherein the heating unit is configured to include:
a heating plate configured to enclose the battery cell unit; and
a heat generating member configured to generate heat electrically.

3. The battery pack structure of claim 2, wherein the heat generating member is disposed outside the heating plate.

4. The battery pack structure of claim 2, wherein the heat generating member is configured integrally with the heating plate.

5. The battery pack structure of claim 2, further comprising:
a guide section configured to enclose the battery cell unit, and includes a guide groove into which sides of the heating plate are configured to be inserted.

6. The battery pack structure of claim 2, wherein the battery cell unit and the heating plate are configured to be separated by 7 mm or less.

7. The battery pack structure of claim 2, wherein the heat generating member comprises one selected from the group consisting of a thermal wire, a silver nanowire, and a PTC material.

8. The battery pack structure of claim 2, wherein the heating plater comprises a metal material.

9. The battery pack structure of claim 1, wherein the control unit controls operation of the heating unit when the temperature sensor unit detects a temperature which is lower than a first critical temperature in a state in which the heating unit is not operated.

10. The battery pack structure of claim 1, wherein the control unit controls operation of the heating unit to be stopped when the temperature sensor unit detects a temperature corresponding to a second critical temperature in a state in which the heating unit is operated.

11. The battery pack structure of claim 2, wherein the heating plate is configured to enclose at least three surfaces of the battery cell unit.

12. The battery pack structure of claim 1, further comprising:
an electrode plate guide located between the battery cells.

13. The battery pack structure of claim 1, wherein the control unit controls operation of the heating unit to be stopped when a preset time has elapsed after the heating unit is operated.
